(19) United States
(12) Patent Application Publication
(10) Pub. No.: US 2004/0202940 A1
(43) Pub. Date: Oct. 14, 2004

(54) Wireless communication system architecture mobile station and method

(76) Inventors: David Kramer, Ginot-Shomron (IL); David Bar-On, Rehovot (IL); Kamala Diane Urs, Bartlett, IL (US); Chantal Balla, Haifa (IL)

Correspondence Address: MOTOROLA, INC., 1303 EAST ALGONQUIN ROAD, IL01/3RD, SCHAUMBURG, IL, 60196

(21) Appl. No.: 10/205,027

(22) Filed: Jul. 25, 2002

(30) Foreign Application Priority Data
May 28, 2002 (GB) 0212198.6

(51) Int. Cl. H01M 10/40; H04B 1/38; H01M 4/48; H01M 4/58; H01M 4/50; H01M 4/52; H01M 10/04

(52) U.S. Cl. 429/306; 455/466; 429/324; 429/231.95; 429/231.1; 429/231.3; 429/224; 429/223; 429/221; 429/231.5; 429/338; 429/342; 455/553.1

(57) ABSTRACT

A wireless communication architecture (100) includes a first wireless communication system (123) operating in the vicinity of a second wireless communication system (173). A System Locator (155) provides at least one operational parameter (330) of the first wireless communication system (123) to at least one dual-mode wireless subscriber communication unit (172) when operating in said second wireless communication system (173) via said second wireless communication system (173). The operational parameter (330) is based on a determined location of the at least one dual-mode wireless subscriber communication unit (172) for use by the at least one dual-mode wireless subscriber communication unit (172) in searching for and/or switching its operation to the first wireless communication system (123). The first system may be a TETRA or iDEN system and the second system may be a GSM system.

### FIELD OF THE INVENTION

This invention relates to a wireless communication system architechture, mobile station for use therein and communication method. In particular, it relates to the transmittal of information on different wireless communication systems. The invention is applicable to, but not limited to, transmission to a wireless communication unit operable in a mobile communications system of at least one operational parameter of a neighbouring dissimilar mobile communication system.

### BACKGROUND OF THE INVENTION

Wireless communications systems, for example cellular telephony or private mobile radio communications systems, typically provide for radio telecommunication links to be arranged between a plurality of base transceiver stations (BTSs) and a plurality of subscriber units, often termed mobile stations (MSs). The term ‘mobile station’ generally includes both hand-portable and vehicular mounted radio units for transmission and receipt of radio communications of speech, data, video etc information.

Wireless communications systems are distinguished over fixed communications systems, such as the public switched telephone networks (PSTN), principally in that mobile stations move between service providers (and/or different BTS) and in doing so encounter varying radio propagation environments.

In a wireless communication system, each BTS has associated with it a particular geographical coverage area (or cell). The coverage area is known as a serving cell and is defined by a particular range from the BTS within which the BTS can maintain acceptable communications with operating MSs. Often these cells overlap and combine to produce an expanded network coverage area. Furthermore, cells are often grouped into location areas for the purposes of tracking a MS within the coverage area whilst minimising location-updating signalling.

In the field of wireless communications, one of the most common complaints from mobile phone or radio customers is the unavailability of service in certain areas owing to lack of good radio frequency (RF) coverage, or lack of system coverage in large geographical areas such as coverage of a state. This is a problem even with MSs that support widely used networks such as the Global System for Mobile communications (GSM). This problem is more prevalent with MSs that support networks that are currently not as widely deployed, for example networks operating specifically for certain organisations, such as TETRA or iDEN™ systems which are usually owned and operated for the benefit of the particular user organisations.

One mechanism that has been chosen by some network operators and MS manufacturers to address the coverage problem is to market dual-mode MSs to support two modes of operation. For example, a basic mode may be for the MS to communicate in a TETRA mode of operation, where direct (radio to radio) mode of communication is supported in addition to cellular operation using the network infrastructure in the TETRA network. As a secondary mode of operation, when the user is in an area where there is no TETRA network coverage available, the MS may be re-configured to operate directly as a cellular phone on a GSM network.

When operating in a GSM mode, the user and the network operator may be interested in returning the user to another network such as an integrated digital enhanced network (iDEN™) network or a TETRA network, as soon as possible, e.g. in order to use the dedicated communication services available.

The Applicant and its subsidiaries produce and market MSs, such as some iDEN MS models that support both an iDEN communication format and a GSM communication format. However, the switching between iDEN and GSM networks is only effected by the user when (s)he recognises that such switching is possible, and manually switches the mode of operation. Alternatively, such switching may occur automatically and without user control, as a user loses coverage on one network and re-registers automatically on the other network.

In particular, a significant disadvantage with a manual switching approach is that the user will be unaware of whether (s)he is within the coverage range of the alternative communication system. The user may switch modes manually and intermittently so that the terminal can search for an alternative network, if the user suspects there might be an alternative network in the area. This is a tedious operation for the user, with no guarantee of successfully finding an alternative network. Additionally, such a manual approach also causes a communication downtime for the user, whilst the terminal is leaving the existing network and searching (perhaps unsuccessfully) for an alternative network. For the abovementioned situation of a dual-mode GSM-TETRA, it will likely take up to several minutes to search for a TETRA network whilst operating in a GSM mode, with no guarantee of success. During this time, the subscriber unit is, as indicated, effectively unusable.

Another solution used in dual-mode wireless communication units is the concept of ‘dual watch’. A dual watch approach, as described in Patent No. GB 2287612, applicant Motorola Ltd., enables a wireless subscriber unit to monitor, periodically, a second network, whilst still communicating on a first network. However, due to differences in, for example, frequency bands, modulation schemes, limits on transmit power, bandwidth restrictions, etc. between dissimilar networks, it is extremely difficult, if not impractical, to implement such a dual watch mechanism.

Clearly, an improved dual-watch mechanism can be implemented using two independent receivers (and potentially two independent transmitters) in a single subscriber communication unit, one receiver configured for each communication system. However, the provision of a dual receiver solution, to constantly monitor the other network, is relatively expensive.

A need therefore exists for an improved mechanism for selecting, and ultimately switching between, wireless communication systems wherein the above-mentioned disadvantages may be alleviated.

### SUMMARY OF THE INVENTION

In accordance with a first aspect of the present invention, there is provided a wireless communication architecture, including a first wireless communication system operating in the vicinity of a second wireless communication system. At least one dual-mode wireless subscriber communication unit is capable of operating in at least the first and second wireless communication systems. A System Locator provides at least one operational parameter of the first wireless communication system, to the at least one dual-mode wireless subscriber communication unit, when operating in the second wireless communication system via the second wireless communication system. The at least one operational parameter is based on a determined location of the at least one dual-mode wireless subscriber communication unit for use by the at least one dual-mode wireless subscriber communication unit in searching for and/or switching its operation to the first wireless communication system.

In accordance with a second aspect of the present invention, there is provided a System Locator, operably coupled to a first wireless communication system and a second wireless communication system. The System Locator provides at least one operational parameter of the first wireless communication system to at least one dual-mode wireless subscriber communication unit operating in the second wireless communication system and capable of operating in at least the first and second wireless communication systems. The at least one operational parameter is based on a determined location of the at least one dual-mode wireless subscriber communication unit. The parameter may be used by the at least one dual-mode wireless subscriber communication unit in searching for and/or switching its operation to, the first wireless communication system.

In accordance with a third aspect of the present invention, there is provided a method of selecting a wireless communication system in a wireless communication architecture that includes a first wireless communication system supporting communications in the vicinity of a second wireless communication system. The method includes the step of operating at least one dual-mode wireless subscriber communication unit in the second wireless communication system and determining a location of the at least one dual-mode wireless subscriber communication unit. At least one operational parameter of the first wireless communication system is provided to the at least one dual-mode wireless subscriber communication unit via the second wireless communication system based on the location determination. The at least one dual-mode wireless subscriber communication unit searches for the first wireless communication system based on the at least one operational parameter.

By providing operational information on a neighbouring communication system or network, an MS may limit the time taken in searching and registering on alternative networks. Preferably, the operational information is received from the MS's home network, via the network it is currently operating in.

Preferably, the dual-mode MS may query its home network about possible alternative networks in the area where the MS is currently operating. When the query includes the MS's geographic location, or information of the network it is currently operating on, the alternative network response can be tailored for the MS's current location.

The network currently supporting communication to/from a MS aids the MS in determining whether or not to attempt to switch systems. This saves the MS from the need to leave the current network in order to perform random searches for an alternative network.

In particular, such a solution to provide operational on a first communication system, via a second (often competing) communication system currently supporting the MS, is believed to be novel and of great benefit to the user.

A particular implementation of the present invention is that whilst operating on a GSM system, the MS will be able to query its home TETRA system as to whether or not there is TETRA coverage in the area were the MS is located. The operational information is preferably communicated using short messages (e.g. a short message service (SMS) on GSM and/or a supplementary data service (SDS) on TETRA). Other methods, such as Internet Protocol (IP) packet data transfer through the Internet, can also be used.

Exemplary embodiments of the present invention will now be described, with reference to the accompanying drawings, in which:

### BRIEF DESCRIPTION OF THE DRAWINGS

FIG. 1 is a block schematic diagram (also reflecting coverage area) of a wireless communication architecture adapted in accordance with a preferred embodiment of the present invention; and

FIG. 2 is a flowchart of events and states of a mobile station and System Locator performing a method of selecting a wireless communication system, in accordance with a preferred embodiment of the present invention.

### DETAILED DESCRIPTION OF EMBODIMENTS OF THE INVENTION

Although the preferred embodiment of the present invention is described with reference to interaction between a TETRA and a GSM system, it is within the contemplation of the invention that the inventive concepts described herein can be applied to any two or more wireless communication systems.

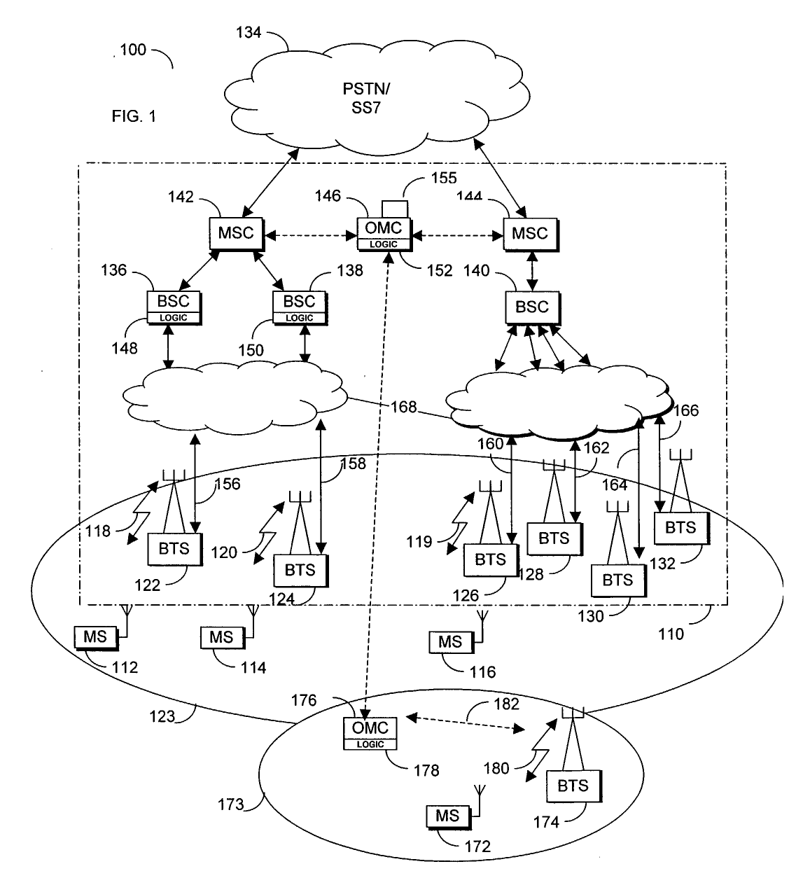

Referring first to FIG. 1, a conceptual diagram 100 of a mixture of communication systems is shown. The diagram includes a trunked radio communication system, supporting a TErrestrial Trunked RAdio (TETRA) air-interface, shown in outline, adapted in accordance with a preferred embodiment of the invention. The European Telecommunications Standards Institute (ETSI) has defined the TETRA air-interface. Generally, the air-interface protocol is administered from base transceiver sites that are geographically spaced apart—one base site supporting a cell (or, for example, sectors of a cell)—with a defined TETRA coverage area 123. A second cellular phone system, for example a Global System for Mobile (GSM) communications, is shown, in the vicinity of the TETRA system with coverage area 173. The GSM air-interface has also been defined by ETSI.

In the TETRA system, a plurality of subscriber units, such as a mixture of MSs 112-116 and fixed terminals (not shown), communicate over the selected air-interface 118-120 with a plurality of base transceiver stations (BTS) 122-132. A limited number of MSs 112-116 and BTSs 122-132 are shown for clarity purposes only.

The system infrastructure in a TETRA system is generally referred to as a switching and management infrastructure (SwMI) 110, which substantially contains all of the system elements apart from the mobile units. The BTSs 122-132 may be connected to a conventional public-switched telephone network (PSTN) 134 through base station controllers (BSCs) 136-140 and mobile switching centres (MSCs) 142-144.

Each BTS 122-132 is principally designed to serve its primary cell, with each BTS 122-132 containing one or more transceivers. The BTSs 122-132 communicate 156-166 with the rest of the trunking system infrastructure via a frame relay interface 168.

Each BSC 136-140 may control one or more BTSs 122-132, with BSCs 136-140 generally interconnected through MSCs 142-144. Each BSC 136-140 is therefore able to communicate with one another, if desired, to pass system administration information therebetween, with BSCs 136-140 responsible for establishing and maintaining control channel and traffic channels to serviceable MSs 112-116 affiliated therewith. The interconnection of BSCs 136-140 therefore allows the trunked radio (or cellular phone) communication system to support handover of the MSs 112-116 between cells.

Each MSC 142-144 provides a gateway to the PSTN 134 and, although not shown, they can provide an interface to a packet data network, e.g. Internet, through some manner of Packet Data Gateway. MSCs 142-144 are interconnected through an operations and management centre (OMC) 146 that administers general control of the trunked radio system 100, as will be understood by those skilled in the art. The various system elements, such as BSCs 136-138 and OMC 146 include control logic 148-152 with the various system elements usually having associated memory. The memory typically stores historically compiled operational data as well as in-call data, system information and control algorithms.

In a preferred embodiment of the present invention, the OMC 146 has been adapted to include a System Locator 155. The System Locator 155 provides information relating to one or more alternative systems offering service or coverage within the geographical areas that are also supported by the TETRA system. In the preferred embodiment of the present invention, the System Locator 155 within the OMC 146 contains operational information relating to the GSM system, supporting GSM communications in coverage area 173.

In accordance with the preferred embodiment of the present invention, the System Locator 155 in the TETRA system is configured to inform the MS 172 operating in the GSM system 173 whether or not there is a TETRA system in the area it is located. Preferably, the System Locator 155 also informs the MS 172 of the radio frequencies the TETRA network uses. This enables the MS 172 to search automatically for a TETRA network only when there is a good chance that there is a TETRA network in its operating area.

When the MS 172 recognises there is a TETRA network in the area, the MS 172 is preferably restricted to search only a limited range of TETRA radio frequencies. The provision of such radio frequency information to MS 172 greatly reduces the amount of time the MS 172 is out of GSM service in searching for a TETRA system. Furthermore, the time it takes to typically find a TETRA network is also reduced.

It is within the contemplation of the invention that the System Locator 155 may be supported in one or more of the communication systems, for example the GSM and/or TETRA communication system of FIG. 1. Alternatively, it is envisaged that the System Locator may be located distal from, but operably coupled to, both wireless communication systems.

The System Locator 155 preferably includes a database that stores locations of known TETRA systems. It is envisaged that the System Locator 155 may also store information on known GSM systems, which is advantageous in situations, for example, where the System Locator 155 was a stand-alone device and operably coupled to both the TETRA and GSM networks.

In addition to the RF channels used by a network, the database preferably includes information on:

(i) Any duplex frequency offset used,

(ii) A list of Control Channel frequencies used by the TETRA networks, and/or

(iii) The geographical boundaries of the TETRA networks if the MS provides geographic location information.

The OMC 146 of the TETRA system is preferably operably coupled to the OMC 176 of the GSM system, at least via the System Locator 155, so that information, such as operating radio frequencies, system timing parameters, etc. relating to both systems can be passed therebetween.

In a similar manner to the TETRA system, the GSM system may include an OMC 176 that is operably coupled to a BTS 174. The BTS supports GSM communication to/from MS 172. The other infrastructure elements of the GSM system, which roughly follow the same principles and architecture of the TETRA system, are not shown for clarity purposes only.

In an alternative embodiment of the present invention, the GSM network broadcasts TETRA-related information to the GSM MSs operating within its network, and vice versa. This solution may require cooperation of both the GSM and TETRA operators to agree to communicate the necessary information to communication units operating in their respective cells. It is appreciated that this alternative embodiment would also likely need amendments to the GSM and/or TETRA standard, in order to facilitate the transmission of such messages.

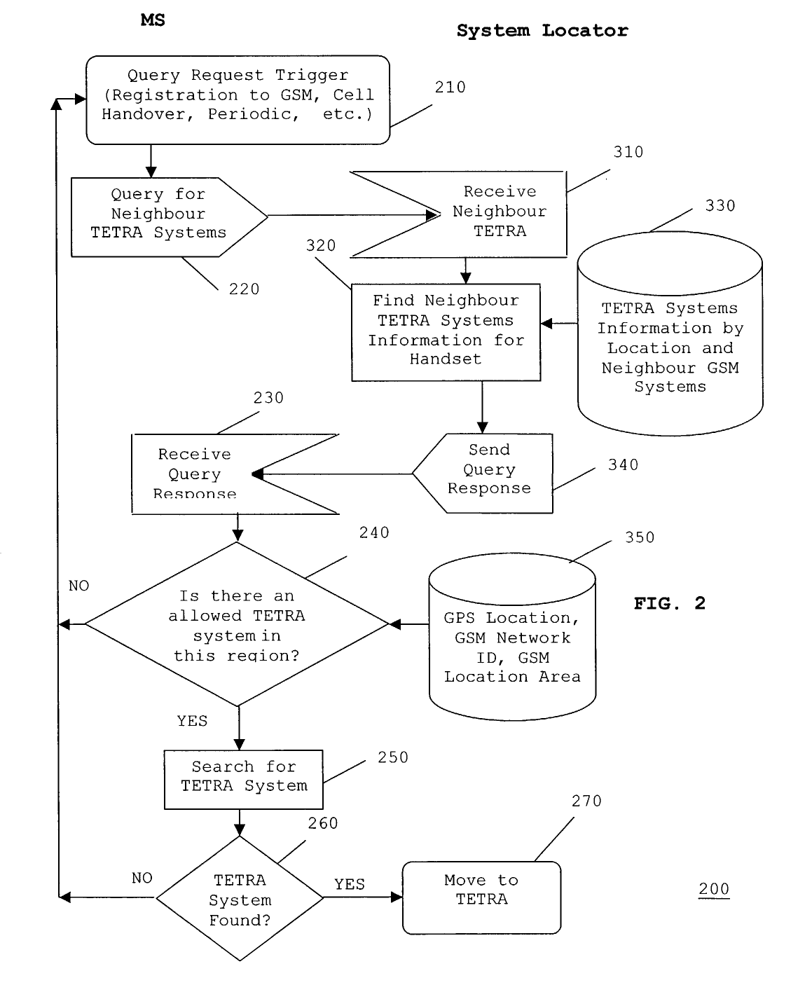

Referring now to FIG. 2, a flowchart 200 of events and states of the MS 172 and System Locator 155 of FIG. 1, when the MS is searching for a TETRA system whilst operating on, say, a GSM system, is shown. When operating in a GSM mode, the dual-mode (GSM-TETRA) MS (for example, MS 172) periodically sends a “Neighbour System Query” short message service (SMS) message to a known ID (phone number) on the TETRA network, as shown in step 220.

The preferred embodiment of the present invention utilises the existing message structure of GSM short message service (SMS) and/or TETRA supplementary data service (SDS) for interface between the MS and the System Locator. However, it is within the contemplation of the invention that other message structure and formats could be used to enable the users and systems to benefit from the inventive concepts described herein.

For example, it is envisaged that the transfer of information may include the use of packet data transmissions to communicate with the System Locator that contains the TETRA and/or GSM system information. Alternatively, the transfer of information may include the use of intelligent networking to trigger communication with the System Locator containing the TETRA and/or GSM system information. The System Locator may then respond via a mobile terminated SMS message.

In contrast to periodic SMS messages being sent to the System Locator 155 of the TETRA system, for example once per hour, it is envisaged that the system information requests may be event-driven as shown in step 210. It is envisaged that such events that could trigger the query, may include:

(i) Registering on a GSM system,

(ii) Cell handover,

(iii) Upon roaming to a new Location Area in the GSM network, etc.

In addition, it is envisaged that any combination of two or more of the above events could be employed at different times or under different circumstances, for example, only on network registration when there is no TETRA system in the area.

Furthermore, it is envisaged that when the home location register (HLR) of the MS's TETRA home network receives a message that the MS is registering on a new GSM network, the System Locator may transmit TETRA system information to the MS, without the need for the MS to request it.

Any query message from the MS may contain various forms of information, as shown in step 350. It is envisaged that such information may include, for example:

(i) Information relating to the current location of the MS supplied, say by a GPS indication,

(ii) A GSM Network ID, and/or

(iii) A GSM Location Area (LA).

The message will be routed to the TETRA network through the network's inter-system interface (ISI).

On the TETRA network, the message will be routed to a System Locator device, as in step 310. It is envisaged that step 310 may potentially include translation to a TETRA SDS message.

If the MS provided geographic location, the System Locator can accurately determine whether the MS is in the coverage area of a TETRA network. If GSM Network ID and/or LA are provided, as in step 330, the System Locator can determine the potential TETRA networks that the MS can search for.

The System Locator then sends a query response to the MS, using, say, a SMS GSM message (or TETRA SDS that will be translated to SMS before being routed to the GSM network), as shown in step 340. The message indicates whether or not there is a TETRA network in the area. If there is a TETRA network in the area, the message also preferably includes information about the radio frequency (RF) channels and/or timing used by the TETRA network(s).

It is envisaged that the System Locator may also send the MS information on the Network IDs of the TETRA networks in the MS's area. In this manner, the MS could choose not to leave the GSM system, and search for a TETRA network, if it knows that none of the TETRA networks are allowed or preferred networks.

It is further envisaged that, where the MS provides geographic location information, the System Locator may also send the MS information on whether the MS is near a TETRA network, so that the MS may search for the network periodically, even before sending the next query, if it so wishes.

When receiving the query response in step 230, the MS determines whether it is in the coverage area of a TETRA network, as in step 240, based on the information received and its location (if known). If the MS determines that it may be in such a coverage area, it will search for the one or more TETRA systems, as shown in step 250. If a TETRA system is found in step 260, the MS may leave the GSM system and register on the TETRA system, as shown in step 270.

If the location determination is based on the GSM Network identifier (mobile network identity (MNI)) and other information such as Location Area from step 350, then it is envisaged that the database may include, for each TETRA network, a list of GSM networks that are active in the coverage area of the TETRA network.

The preferred configuration of operably coupling the System Locator to the alternate network (e.g. GSM) via an OMC link is shown as an example only. It is envisaged that a further example of a connection from the System Locator to the alternate network may be through a visitor location register (VLR)/home location register (HLR) interface.

In an alternative configuration, the System Locator may be connected to the alternate network via a short message service centre (SMSC) routing the messages directly to the System Locator, for example using an Internet protocol (IP)-based structure. A skilled artisan would appreciate that other network configurations could also benefit from the inventive concepts described herein. Additionally, the two or more wireless communication systems may be adjacent one another, overlapping, or substantially contained within one another in a pico-cell to micro-cell to macro-cell manner. As such, the wireless communication systems only need to be in the vicinity of one another to facilitate a potential hand-over of wireless communications therebetween.

The inventive concepts find particular application in use between dissimilar communication systems, for example a GSM cellular communication system and a private mobile radio communication system. It is within the contemplation of the invention that such routing of neighbouring system information may be utilised in any other wireless communication system, such as a wireless local area networks (WLANs), a third generation partnership project (3GPP) communication system, etc.

Although the aforementioned inventive concepts have been described with reference to interaction between TETRA and GSM systems, it is within the contemplation of the present invention that such concepts can be applied to other types of wireless cell-based communication systems. For example, an MS operating on a GSM system may receive information on neighbouring iDEN™ systems and vice versa; an MS operating in IS-136 system may receive information on neighbouring GSM systems and vice versa; an MS operating on a foreign TETRA system may receive information on its Home TETRA system.

Although the invention preferably utilises the GSM SMS and TETRA SDS mechanism to transfer messages between the MS and the System Locator, it is envisaged that other mechanisms may be used. For systems other then TETRA and GSM, it is envisaged that their particular short message mechanism(s) may replace the GSM SMS or TETRA SDS message formats. In addition, the interface between the two or more systems may be implemented using other methods, such as IP messages, where the System Locator can be connected to the Internet. Advantageously, if an Internet interface is used, no agreement between the system operators is required.

Furthermore, it is envisaged that a third party may provide a stand-alone System Locator that can be operably coupled to any two or more neighbouring (or overlapping) wireless communication systems. However, such an implementation would need to consider the security aspects associated with implementing such a standard interface to multiple wireless communication systems.

It will be understood that the wireless communication architecture and method of selecting a wireless communication system, as described above, provides at least the following advantages:

(i) An MS may limit the time taken in searching and registering on alternative networks by receiving information about alternative networks from, say, the MS's home network, via the network it is currently operating in.

(ii) By including Network IDs (MNIs) in the communication to the MS, the MS can check whether it has received authorisation to operate on the alternative networks in its current location, without first needing to start a registration process with, or connect to, the alternative network.

(iii) A mechanism is provided for a dual-mode MS to query, say, its home network about possible alternative networks in the area where the MS is currently operating. When the query includes the MS's geographic location, or information of the network it is currently operating on, the alternative network response can be tailored for the MS's current location.

(iv) The network currently supporting communication to/from a MS aids the MS in determining whether or not to attempt to switch between systems. This prevents the MS from needing to leave the current network in order to perform random searches for an alternative network.

(v) A variety of message formats may be used to inform the MS of alternative systems, for example, SMS messages to interface with the System Locator when it is located within the TETRA system or using Packet Data when it is communicating via, say, the Internet.

Whilst specific, and preferred, implementations of the present invention are described above, it is clear that one skilled in the art could readily apply variations and modifications of such inventive concepts.

Thus, an improved mechanism for monitoring, and ultimately switching between, wireless cellular-based communication systems has been described wherein the aforementioned disadvantages associated with prior art arrangements have been substantially alleviated.

1. A wireless communication architecture comprising a first wireless communication system operating in the vicinity of a second wireless communication system, where at least one dual-mode wireless subscriber communication unit is capable of operating in at least the first and second wireless communication systems, comprising a System Locator that is operable to provide at least one operational parameter of said first wireless communication system to said at least one dual-mode wireless subscriber communication unit when operating in said second wireless communication system, wherein said at least one operational parameter is based on a determined location of the at least one dual-mode wireless subscriber communication unit for use by the at least one dual-mode wireless subscriber communication unit in searching for or switching its operation to said first wireless communication system.

2. The wireless communication architecture according to claim 1, wherein said System Locator is operable to provide said information in response to receiving a network request for said at least one operational parameter from said at least one dual-mode wireless subscriber communication unit.

3. The wireless communication architecture according to claim 2, wherein in operation said network query is generated by either (i) a substantially periodic, or time-dependent transmission from at least one dual-mode wireless subscriber communication unit; or (ii) in response to an event.

4. The wireless communication architecture according to claim 1, wherein said System Locator is incorporated within a management control function in one of said wireless communication systems.

5. The wireless communication architecture according to claim 1, wherein said System Locator is operable to store operational information relating to said second wireless communication system, in addition to information relating to said first wireless communication system.

6. The wireless communication architecture according to claim 1, wherein said first wireless communication system and said second wireless communication system are dissimilar communication systems.

7. The wireless communication architecture according to claim 1 wherein the first communication system is a TETRA (Terrestrial Trunked Radio) wireless communication system and the second communication system is a GSM (General System for Mobile communications) wireless communication system.

8. The wireless communication architecture according to claim 1 wherein the first communication system is an iDEN (Integrated Dispatch Enhanced Network) wireless communication system and the second communication system is a GSM (General System for Mobile communications) wireless communication system.

9. A System Locator, operably coupled to a first wireless communication system and a second wireless communication system, wherein the System Locator is operable to provide information to at least one dual-mode wireless subscriber communication unit operating in the second wireless communication system and capable of operating in the first wireless communication system, such that said information relates to a determined location of the at least one dual-mode wireless subscriber communication unit and includes at least one operational parameter of said first wireless communication system for use by the at least one dual-mode wireless subscriber communication unit in searching for or switching its operation to said first wireless communication system.

10. A method of selecting a wireless communication system in a wireless communication architecture that includes a first wireless communication system supporting communications in the vicinity of a second wireless communication system, the method comprising the steps of:
operating at least one dual-mode wireless subscriber communication unit in said second wireless communication system; and
determining a location of said at least one dual-mode wireless subscriber communication unit;
providing at least one operational parameter of said first wireless communication system to said at least one dual-mode wireless subscriber communication unit via said second wireless communication system based on said determination; and
selecting, by said at least one dual-mode wireless subscriber communication unit, to operate in said first wireless communication system in response to said at least one operational parameter.

11. The method of selecting a wireless communication system according to claim 10, which further comprises the step of:
requesting, by said at least one dual-mode wireless subscriber communication unit, said at least one operational parameter in one or more of the following ways:
(i) a substantially periodic, or time-dependent transmission, for example a short message service or supplementary data service message, from at least one dual-mode wireless subscriber communication unit;
(ii) in response to an event.

12. The method according to claim 11, wherein said event includes said at least one dual-mode wireless subscriber communication unit performing at least one step of the set consisting ofof the following:
(i) registering on said second wireless communication system,
(ii) performing a cell handover: and
(iii) roaming to a new location area.

13. The method according to claim 12, wherein said request includes at least one of the set consisting of:
(i) information relating to a location of the at least one dual-mode wireless subscriber communication unit;
(ii) a Network identifier of the second wireless communication system, and
(iii) a Location Area identifier of the second wireless communication system.

14. The method according to claim 13, wherein said information relating to said first wireless communication system includes information relating to at least one of the set consisting of:
(i) at least one radio frequency used;
(ii) a duplex frequency offset;
(iii) a list of Control Channel frequencies;
(iv) at least one timing parameter; and
(v) a geographical boundary of the first wireless communication system.

15. The method according to claim 14, wherein said at least one dual-mode wireless subscriber communication unit determines whether to search for said first communication network, based on the information received and its location.

16. A mobile station operable in at least first and second wireless communication systems, the station being operable when operating in the first system to send periodically signals including information about current location of the mobile station to a System Locator to determine automatically whether it is within range of the second system.

17. A mobile station according to claim 16 and which is operable to send the said signals by text or data message signalling.

18. A mobile station according to claim 17, wherein the mobile station is operable to receive from the System Locator when appropriate signals indicating that the mobile station is within operational range of the second system and optionally in response to search for operational channels in the second system or to switch to transmit and receive communications in the second system.
